(19) United States
(12) Patent Application Publication
(10) Pub. No.: US 2009/0072037 A1
(43) Pub. Date: Mar. 19, 2009

(54) Autofocus liquid lens scanner

(75) Inventors: Timothy A. Good, Clementon, NJ (US); Xiaoxun Zhu, Marlton, NJ (US)

Correspondence Address: DUANE MORRIS LLP - Allentown, 968 POSTAL ROAD, SUITE 110, P.O. BOX 90400, ALLENTOWN, PA, 18109-0400, US

(73) Assignee: Metrologic Instruments, Inc.

(21) Appl. No.: 11/901,342

(22) Filed: Sep. 17, 2007

(51) Int. Cl. G06K 7/10

(52) U.S. Cl. 235/462.35

(57) ABSTRACT

An autofocus system and method for performing the same for a liquid lens. The autofocus system in one embodiment includes a liquid lens having a variable focal length that is adjusted by varying an input voltage to the lens, distance detection circuitry operative to measure a distance to a target to be scanned, and control circuitry associated with the liquid lens for focusing the lens. The control circuitry receives a signal from the distance detection circuitry representing a measured distance to the target. Control logic, preferably implemented by the control circuitry in one embodiment, calculates a voltage value corresponding to the measured distance to the target and generates an output voltage approximating the calculated voltage value to adjust the focus the lens.

### FIELD OF THE INVENTION

The present invention relates to fluid or liquid lenses, and more particularly to an improved method and system for automatically focusing and zooming a liquid lens suitable for incorporating into compact handheld devices.

### BACKGROUND

Barcode readers or scanners are found in many commercial environments such as, for example, point-of-sale stations in retail stores and supermarkets, inventory and document tracking, and diverse data control applications. To meet the growing demands, barcode symbol readers of various types have been developed for scanning and decoding barcode symbol patterns and producing symbol character data for use as input in automated data processing systems. Bar code scanners generally are available in hand-held, hands-free or in-counter formats.

Typical laser barcode scanners have a fixed focus of the laser beam which puts a limitation on the depth of field (DOF) and resolution of the scanner needed to read a barcode. Imaging scanners and engines often employ CMOS or CCD sensors coupled to fixed focus optics, or optics with preset focus locations that the user can select offline. Such conventional auto focus scanners heretofore have typically used lens systems employing mechanical movements and multiple moving parts to vary the focal length of the lenses, which are typically glass or plastic. The field of view (FOV) of these imaging devices have fixed angles so that the size (width) of view varies depending on the distances of the target from the image device. In image lifting applications such as barcode scanning, this poses a significant challenge for the user to capture the desired target entirely and consistently with satisfactory resolution to read the barcode, even aided with mechanical targeting and framing apparatus. Therefore, in order to bring the barcode into focus for reading, the user must sometimes resort to either moving the object with barcode to be scanned for fixed mount scanners, or moving the scanner until the barcode is read in the case of handheld scanners. Either situation may be cumbersome for the user, increases scanning time, and reduces overall scanning efficiency.

Recent developments in optics has produced very compact variable-focus liquid lens technology that has no mechanical moving parts. Because of the compact design and low power consumption attributes, such liquid lens technology is well suited for bar code scanning applications. A fluid or liquid lens has no moving parts and the focus is simply controlled by a voltage change. Compared to conventional moving-part mechanical lens systems, a liquid lens system therefore advantageously has fast focusing/zooming capabilities and is inherently more reliable owing to its simple design. In addition, a liquid lens can be made relatively small in size with typical diameters of about 3 mm in some embodiments.

A liquid lens generally includes two immiscible (non-mixable) fluids each having a different refractive index. One fluid is typically water which is electrically conducting. The other fluid is typically an electrically non-conducting oil. The fluids are contained in a cylinder or short tube that has a hydrophobic coating applied to the inner walls and two optically clear ends through which light can pass. A meniscus is formed at the interface between the water and oil that has a hemispherical shape and functions like a spherically curved optical lens.

The liquid lens is focused by changing the shape of the meniscus via applying an electric field across the hydrophobic coating to vary the degree of hydrophobic or water-resistant property. This technique is referred to as electrowetting, which is produced by electrically inducing a change in surface tension of the water. The change in surface tension alters the radius of curvature of the meniscus between the two fluids and hence the focal length of the lens. By varying the electric signal or voltage to the liquid lens, the curvature of the meniscus or lens can concomitantly be varied from an initial convex shape in one position to concave in another position and every shape therebetween including flat. The lens shape transitions can be effected smoothly and quickly, without any moving parts. Liquid lenses are available from companies such as Philips Electronics and Varioptic S. A. A liquid lens may be coupled with CCD or CMOS to create compact image reading and capture devices. Because a liquid lens represents a capacitive load, power consumption is relatively small making it suitable for battery-powered and rechargeable devices. However, the problem of effectively and quickly varying the focus of such devices for bar code scanning applications remains.

Although auto focusing/zooming systems with IR transceiver distance detection have been implemented in conjunction with conventional mechanical moving-part lens autofocus lens systems (described above) in barcode scanning applications, the size of mechanisms and amount of control circuitry and software typically do not permit compact equipment packages to be created such as those required for handheld scanners or scanning engine products. Accordingly, an improved, compact fast-acting autofocus liquid lens system with distance detection and real-time feedback is desired.

### SUMMARY

A liquid lens autofocus system is provided that includes distance detection and real-time feedback control to focus the lens. In a preferred embodiment, the autofocus system is integrated into a laser barcode scanner. The distance detection system is used to vary the voltage to the liquid lens and change the focus, and in some embodiments also the zoom, of the lens. For scanning and reading barcodes, because the field of view (FOV) changes, it is also advantageous to include zoom capabilities to frame the entire barcode image (width of field) to be captured and read by the scanner since a relatively constant resolution (dpi) is desired regardless of distance to the target.

In a preferred embodiment, the liquid lens with autofocus system including distance detection circuitry is small enough to fit in a housing that is sized and configured for being held in the hand. In one embodiment, the housing forms part of a handheld scanner that may be used to read barcodes. In other embodiments, the autofocus system may be incorporated into a fixed mount scanner.

According to one embodiment, a liquid lens autofocus system includes a first liquid lens having a variable focal length that is adjustable by varying an input voltage to the liquid lens; distance detection circuitry being operative to measure a distance to a target to be scanned; and control circuitry associated with the first liquid lens for focusing the lens. The control circuitry preferably is operative to receive a signal from the distance detection circuitry representing a measured distance to the target. The autofocus system further includes control logic implemented by the first liquid lens control circuitry which is operative to calculate a first voltage value corresponding to the measured distance to the target. The control logic may be implemented in hardware, firmware, software, or any combination thereof. The control circuitry generates an output voltage corresponding to the first voltage value to adjust the focus of the first liquid lens.

In one embodiment, the control logic includes a lookup table containing a plurality of voltage values versus corresponding distance values. The control logic accesses the lookup table to calculate the first voltage value based on the measured distance to the target. In another embodiment, the first voltage value is calculated by the control logic using a mathematical expression based on the measured distance to the target. In one embodiment, the distance detection circuitry may use without limitation an infrared beam, LED, laser, or interferometry range finding to measure the distance to the target.

In one embodiment, the liquid lens autofocus system is employed in a scanner, which may a laser barcode scanner in some embodiments. In another embodiment, the autofocus system is preferably sized and configured to fit in handheld scanner, and more preferably in a handheld barcode scanner. Accordingly, the target may be a barcode in some embodiments.

The liquid lens autofocus system may further include control logic implemented by the first liquid lens control circuitry that calculates a zoom ratio based on the measured distance to the target. Accordingly, the distance detection system is used to focus and set a zoom ratio for the liquid lens based on the distance measured to the target.

According to another aspect of the invention, a scanner with liquid lens autofocus system includes a housing; distance detection circuitry disposed in the housing and being operative to measure a distance to a target; a first liquid lens disposed in the housing and having a variable focal length that is adjustable by varying an input voltage to the liquid lens; control circuitry associated with the first liquid lens for focusing the lens, the control circuitry being operative to receive a signal generated by the distance detection circuitry representing a measured distance to the target; and control logic implemented by the liquid lens control circuitry. The control logic is operative to read the measured distance to the target and calculate a first voltage value corresponding to the measured distance.

The control logic in one embodiment includes a lookup table containing a plurality of voltage values versus corresponding distance values. The control logic accesses the lookup table to calculate the first voltage value based on the measured distance to the target. In other embodiments, the first voltage value is calculated by the control logic using a mathematical expression based on the measured distance to the target. The control logic incorporates a predefined range of focal distances for the liquid lens. The predefined range of focal distances (i.e. the “focal range” of the scanner) is selected to encompass the full range of possible target image distances the scanner would expect to encounter during actual use in field conditions. In other words, the predefined focal range is sufficiently large so that when a target image is presented to the scanner by a user to be read by the scanner, there preferably would not be a situation where the target image is outside the predefined focal range of the liquid lens.

Aided by the control logic, the control circuitry generates an output voltage equal to the calculated first voltage value to automatically adjust and set the focal length of the variable focus first liquid lens. In one embodiment, the housing is sized and configured for being held in a hand of a user. In a preferred embodiment, the handheld housing is a portable barcode scanner.

In one embodiment, the scanner preferably further includes a laser source supported by the housing for generating a laser beam for scanning a target image. The laser source is operative to generate a laser beam, which preferably is transmitted through and focused on the target image through the first liquid lens. Advantageously, the variable focus liquid lens has already been adjusted to an appropriate focal length by the control logic and control circuitry based on the measured distance to the target image so that an optimal resolution of the laser beam on the scanned image is achieved. In a preferred embodiment, the target image is a barcode which is readily scanned and read due to the proper focal length of the liquid lens having been automatically selected.

In some embodiments, the distance detection circuitry uses an infrared beam, LED, laser, or interferometry range finding to measure the distance to the target. Other suitable methods may be implemented and used by the distance detection circuitry so long as the distance to the target can be measured and that measurement in turn transmitted to the liquid lens control circuitry via a data communication link. In some embodiments, a second liquid lens may be provided in combination with the first liquid lens. The first and second liquid lens may define part of a zoom lens system for both focusing the liquid lens on and framing the target image via selection of an appropriate zoom ratio for the liquid lens.

According to another aspect of the invention, a method of focusing a liquid lens on a target includes the steps of: providing a liquid lens having a focal length that is adjustable by varying an input voltage to the liquid lens; presenting a target separated from the liquid lens by a distance; measuring the distance to the target with a distance detection system; calculating a first voltage value corresponding to the measured distance to the target; generating a focus control voltage corresponding to the first voltage value; receiving the focus control voltage by the liquid lens; and adjusting the focal length of the liquid lens based on the focus control voltage. In another embodiment, the focal length of the liquid lens represents an optimal resolution of the target. In one embodiment, the calculating step includes implementing control logic to calculate the first voltage value based on the measured distance to the target. In another embodiment, the calculating step includes implementing control logic operative to match the measured distance to the target to the first voltage value. The control logic may access a lookup table including a plurality of voltage values versus corresponding distance values to perform the match in some embodiments. The distance detection system in some embodiments includes circuitry that uses an infrared beam, LED, laser, or interferometry range finding to measure the distance to the target.

The method may further include providing a laser source which is supported by the housing in some embodiments and is operative to generate a laser beam. The method further includes in some embodiments a step of projecting the laser beam through the liquid lens onto the target. In a preferred embodiment, the target is a barcode. The liquid lens may be disposed in a housing that is sized and configured for being held in a hand of a user in another preferred embodiment. The distance detection system preferably is also disposed in the housing. In a preferred embodiment, a device with the liquid lens projecting the laser beam is a laser barcode scanner.

In another embodiment, the method further includes a step of the liquid lens collecting light, receiving an image reflected from the target, and forming an image of the target. The target may be a barcode which is illuminated by a light source, the reflected light of which is collected by the liquid lens. In one embodiment, the method further includes a step of capturing the image on a CCD or CMOS image sensor for further processing. In a preferred embodiment, a device with liquid lens collecting and capturing the reflected light and forming an image is a barcode reader.

The apparatus and method disclosed herein advantageously provides a liquid lens system with distance detection for improved and quick focus/zoom that can be housed in compact, light-weight, and portable handheld packaging in some embodiments such as handheld laser barcode scanners.

### BRIEF DESCRIPTION OF THE DRAWINGS

The features of the preferred embodiments will be described with reference to the following drawings where like elements are labeled similarly, and in which:

FIGS. 1A-1C are schematic diagrams of a liquid lens according to principles of the present invention under various input voltage conditions;

FIG. 2A is a schematic diagram of an autofocus system incorporating the liquid lens of FIG. 1 according to an embodiment of a barcode reader;

FIG. 2B is a schematic diagram of an autofocus system incorporating the liquid lens of FIG. 1 according to an embodiment of a laser barcode scanner;

FIG. 3 is a schematic diagram according to another embodiment of an autofocus system incorporating the liquid lens of FIG. 1 and system of FIG. 2A.

FIG. 4 is a schematic diagram of a liquid lens driver useable with the liquid lens of FIG. 1 according to an embodiment;

FIG. 5 is a flowchart showing exemplary control logic for operating the foregoing autofocus systems according to an embodiment; and

FIG. 6 is a plot showing lens curves representing resolution/depth-of-field (DOF) versus target distance from a lens according to an embodiment.

All drawings are schematic and are not drawn to scale.

### DETAILED DESCRIPTION

This description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation. Terms such as “attached,” “affixed,” “connected” and “interconnected,” refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the preferred embodiments. Accordingly, the invention expressly should not be limited to such preferred embodiments illustrating some possible non-limiting combination of features that may exist alone or in other combinations of features; the scope of the invention being defined by the claims appended hereto.

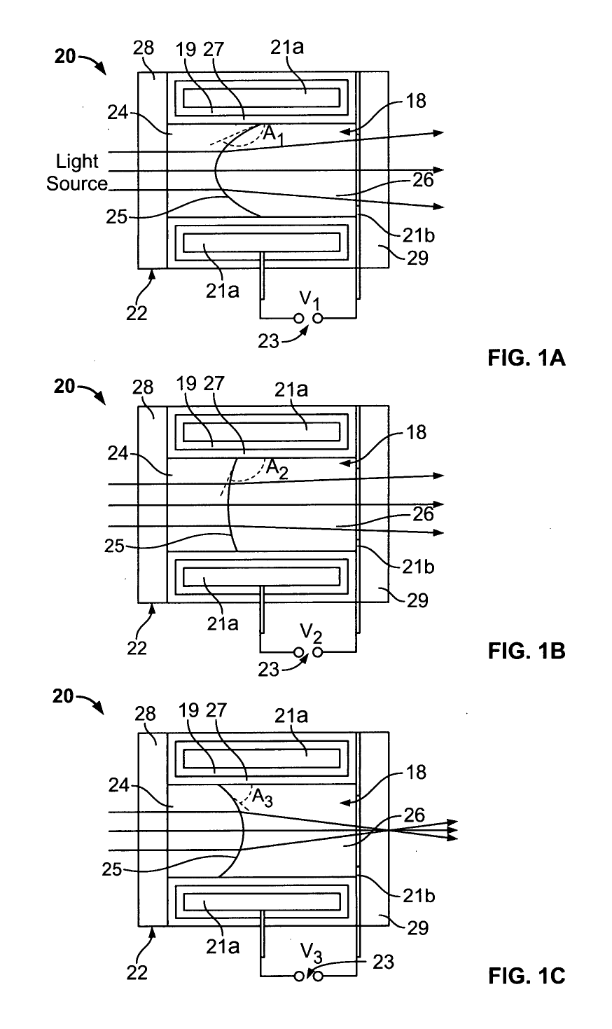

Referring to FIGS. 1A-1C, a schematic diagram is shown of one possible embodiment of a liquid lens 20 useable with the autofocus scanner system described herein. Liquid lens 20 includes a hollow cylindrical body 22 defining an internal chamber 18 and having two sealed ends 28, 29 which preferably are transparent to allow the passage of light energy. A pair of electrodes 21 are provided which are connected to an electric energy or power source 23 and an associated circuit that supplies an electric voltage V to liquid lens 20. In one embodiment, power source 23 is DC. Power source 23 is used to create an electrical potential across a pair of spaced-apart electrodes 21a, 21b for controlling the focus of liquid lens 20. Electrode 21a is separated from the internal chamber of body 22 by an insulator 19. Liquid lens 20 further includes an insulating fluid 24 such as an oil in one embodiment and a conducting fluid 26 such as water in one embodiment. A meniscus 25 is defined at the interface between the two fluids 24, 26 and meets the inside of liquid lens body 22 at variable angles of contact A₁-A₃. A hydrophobic coating 27 applied on the inside of liquid lens body 24 causes the conductive fluid 26 to be repelled and assume a generally hemispherical shape at meniscus 25. Meniscus 25 acts as a curved optical lens. As mentioned above, the shape or curvature of the meniscus 25 can be changed to adjust the focus of liquid lens 20 along a continuum of positions from convex (FIG. 1A) to concave (FIG. 1C) by varying the input voltage V across electrodes 21a, 21b, as represented for example by voltages V₁-V₃ having different values. The change in voltage concomitantly changes the angles of contact A₁-A₃ between the meniscus 25 and inside walls of liquid lens body 22.

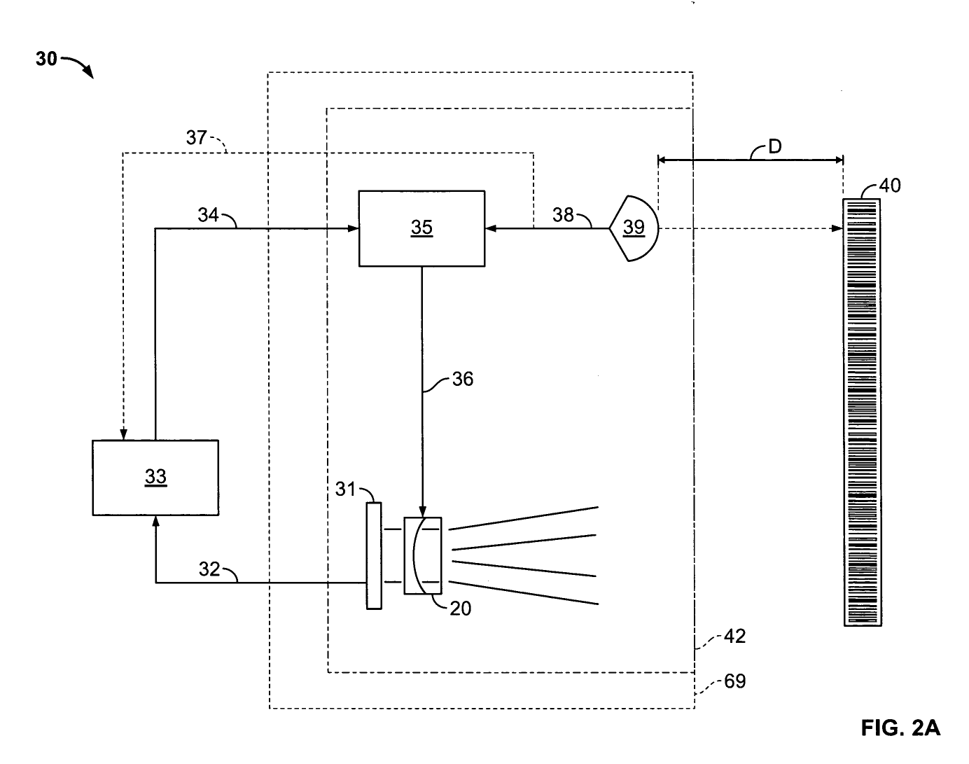

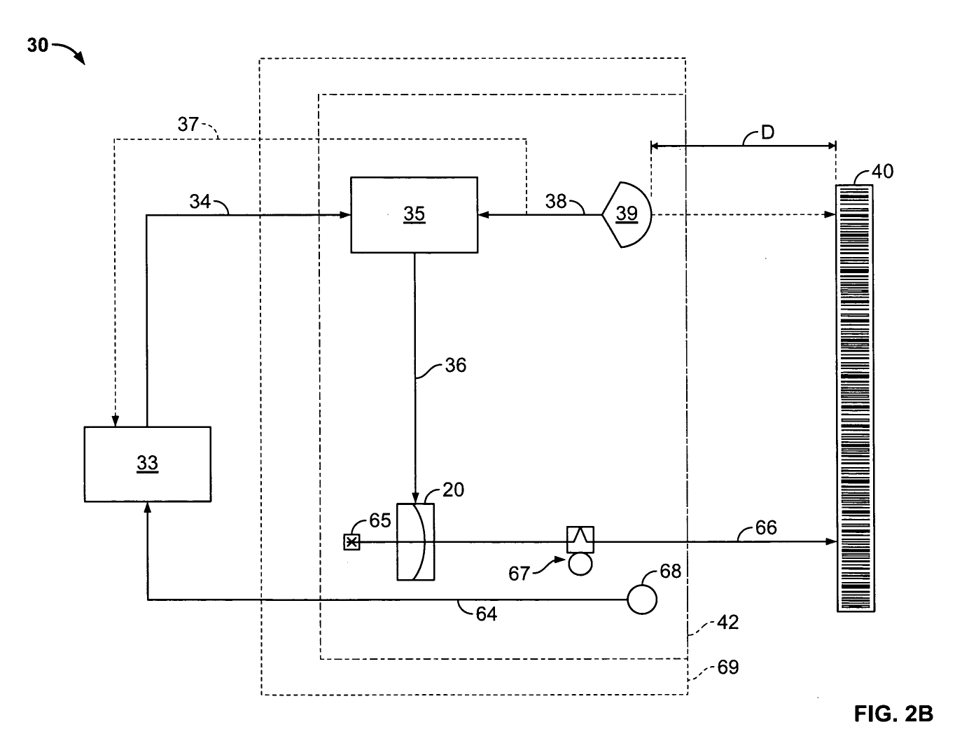

FIGS. 2A and 2B depict embodiments of an autofocus system 30 for controlling the focus and zoom of liquid lens 20. The primary components of autofocus system 30 generally include liquid lens 20, a distance detection system 39 for measuring the distance to a scanned object; control circuitry/circuit 35 including electronics for processing data from the distance detection system and controlling the operation of liquid lens 20, and one or more microprocessors 33 for processing data about the scanned object.

FIGS. 2A and 2B show different variations of a liquid lens autofocus,system 30 for two types of barcode scanning systems. FIG. 2A shows an autofocus system 30 in an application for a barcode image reader, which functions much like a photographic camera. Liquid lens 20 is coupled to a pixilated full array image capture sensor 31, such as a CCD (charged coupled device) or CMOS (complimentary metal-oxide semiconductor) that essentially converts sensed or received light energy from the scanned image into electrical charges. Image sensor 31 is a linear photodiode array consisting of a plurality of individual tiny photodiodes. In this application, liquid lens 20 serves as image capture device which samples or receives the visual image of the entire scanned barcode symbol at once. The barcode symbol or target 40 is typically first illuminated by a light source. Liquid lens 20 then receives and focuses the reflected light onto photosensitive image sensor 31. The image information captured by image sensor 31 is digitized and decoded/interpreted by the electronics associated with the image sensor and/or a microprocessor 33.

As illustrated schematically in FIG. 2A, liquid lens 20 with closely coupled image sensor 31, control circuitry 35, and distance detection system 39 are typically mounted on a PC board or “optical bench” 42 as known in the art that is disposed in a housing 69. Microprocessor 33 may be disposed in housing 69 or external to the housing depending on the scanner package configuration. In some embodiments, housing 69 is sized and configured to be held in the hand of a user such as a handheld scanner.

FIG. 2B shows a liquid lens autofocus system 30 in an application for a laser barcode scanner. In contrast to the barcode reader application shown in FIG. 2A in which liquid lens 20 collects or receives light (i.e., barcode image), the liquid lens in the laser scanner of FIG. 2B serves as a conduit to project and focus a laser onto a barcode target 40 to be read. Accordingly, liquid lens 20 in FIG. 2B focuses a light source (i.e., a laser) on the target while liquid lens 20 in FIG. 2A focuses reflected light (e.g., a barcode image).

The laser scanner autofocus system 30 of FIG. 2B generally includes distance detection system 39, liquid lens 20, control circuit 35 which operates to adjust the focus the liquid lens 20, and microprocessor 33, similarly to that shown in FIG. 2A. However, liquid lens 20 is not coupled to an image sensor 31 as shown in FIG. 2A. Instead, a laser source 65 is provided which projects a laser beam 66 through liquid lens 20 on a path toward a barcode target 40. As explained further herein, liquid lens 20 is set to an appropriate focal length based on information from distance detection system 39 and focuses laser beam 66 on target 40. Functionally interspersed between liquid lens 20 and target 40 is an oscillating mirrored flipper which deflects the single laser beam 66 to linearly scan the beam back and forth in one embodiment along a line for reading the barcode. In lieu of capturing the entire barcode image at once like a barcode reader shown in FIG. 2A, a laser scanner moves or scans a single focused point of laser beam 66 across the barcode from side to side scanning each bar of the code individually in sequence (albeit this occurs almost instantaneously in practice). The laser beam 66 reflects back alternating patterns of light and dark areas as the laser moves from dark bars to interspersed light areas between the dark bars. The reflected light is captured by a simple photocell 68, which typically is placed proximate to the front of optical board 42 and housing 60 facing target 40 close to where laser beam 66 exits the front of the scanner. Photocell 68 communicates the captured light reflection data to microprocessor 33 via a data communication link 64 for interpretation and further processing.

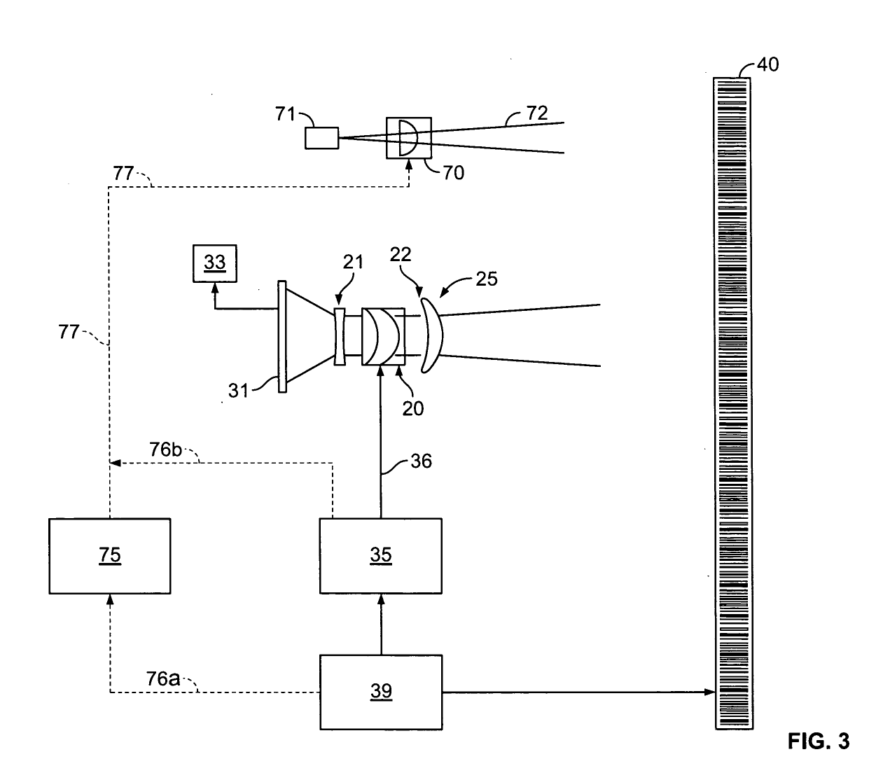

As shown in FIG. 3, a liquid lens system 25 for an barcode reader may be provided that includes zoom capabilities. For reading barcodes, it is advantageous to include zoom to frame the entire barcode image to be captured and read by the scanner because a constant resolution (dpi) is desirable regardless of the distance between the scanner and target 40. The configuration of autofocus system 30 is essentially the same as shown in FIG. 2A with exception of the lens system. In one embodiment of a liquid lens system 25 with zoom capability, fixed focal length lenses 21, 22 are added on either side of liquid lens 20. Lens 21 in some embodiments may be a wide angle objective lens. In other embodiments, two liquid lenses 20 may be provided between fixed focal length lenses 21, 22. Accordingly, the invention is not limited by the configuration or types and numbers of liquid and fixed lenses used in the zoom system.

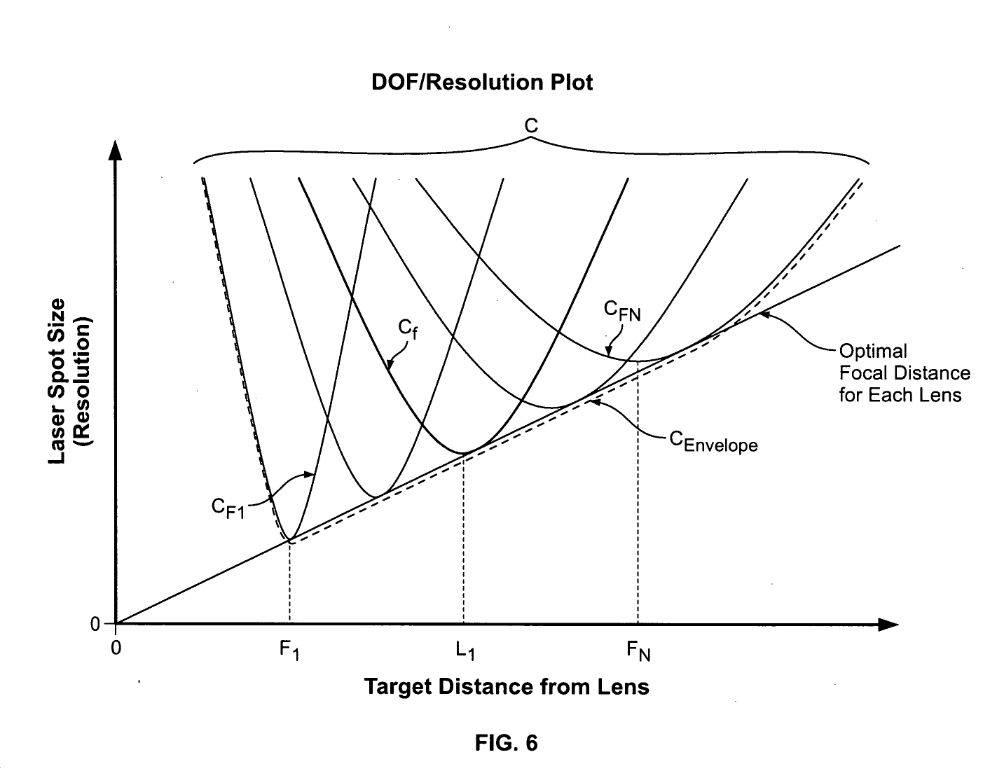

Referring to FIG. 6, a plot is shown of depth-of-field (DOF) or resolution (i.e., the laser beam spot size) versus distance of the target from the lens. A series or set of curves C are shown with each curve representing a lens with a single focal length. FIG. 6 will first be explained without limitation by way of example with reference to a laser barcode scanner application. In the case of a laser barcode scanner, each curve C represents a Gaussian profile of a laser beam with each curve C further representing the size of the laser spot produced by the scanner for reading a barcode. The optimum resolution for any given lens of a fixed single focal distance/length (represented by each curve C) occurs at the bottom of each curve C. This is the point of desired optimum resolution where the smallest laser spot size is produced for reading a barcode. The smaller the laser spot size produced, the greater the ability of the scanner to resolve the individual bar code lines needed to read the barcode. Accordingly, for any of the given curves C shown, it will be apparent that the bottom point establishes a corresponding ideal or optimum distance of the target from the lens. For example, if a standard single lens having a fixed focal length is used as identified by the solid curve Cf in FIG. 3, the corresponding ideal distance of optimum resolution from the target would be L₁. If the actual distance of the target to be scanned to the lens is greater or less than the ideal target distance L₁, the resulting resolution may be insufficient for the barcode to be resolved and read. Therefore, in the case of a fixed mount scanner, the target distance from the lens has to be manually adjusted until the target is close enough to L₁ for the barcode to be resolved and read. For a handheld scanner, the scanner must be moved forward and/or rearward sometimes several times to vary the distance of the lens from the target until the barcode can be sufficiently resolved and read. Either situation is undesirable and increases scanning time.

In the case of a barcode imager, each curve C in FIG. 6 represents a possible focal length for resolving the barcode target that will bring the barcode image into optimal focus on image sensor 31. The proper focal length will depend on distance D from liquid lens 20 to the target 40.

With continued reference to FIG. 6, the present invention including a liquid lens system coupled with a distance detection system to adjust the focal length of the liquid lens advantageously provides a set of individual beam profiles that forms a range of available resolutions from a minimum focal length at curve C_{F1} having a focal distance F₁ (representing the shortest possible target distance to the lens that can be resolved/read) to a maximum focal length at curve C_{FN} having a focal distance F_{N} (representing the longest possible target distance to the lens), and including essentially a continuum of possible curves in between (where “n”=the number of curves in the set of beam profiles). An envelope C_{Envelope} of possible curves (dashed line shown in FIG. 6) are possible using the liquid lens with distance detection system bounded by curves C_{F1} and C_{FN}. As explained herein, the autofocus system 30 according to principles of the present invention selects the optimum lens curve C for maximum resolution based on the distance of the target from the lens measured by distance detection system 39. Each curve C is preferably correlated to a required input voltage V to liquid lens 20 needed to focus the lens and achieve the required focal length for optimal resolution of the target. It is well within the ambit of one skilled in the art to make this determination.

With reference generally to FIGS. 2A, 2B, and 3, distance detection system 39 may be any commercially available system and includes circuitry capable of measuring the distance to a target to be scanned. In one embodiment, distance detection system 39 may be a multi-signal-level IR transceiver system that measures a distance D to a target 40. In one embodiment, target 40 may be a barcode target that includes a barcode for scanning and reading into a barcode scanning system. In some equipment configurations, target 40 may be spaced from liquid lens 20 by a distance that is different than distance D from distance detection system 39 to the target. For purposes of focusing liquid lens 20 on target 40, the relevant distance D is between the target and lens. Accordingly, in some embodiments, a correction factor may be applied to the measured distance D in either hardware, firmware, or software to yield a representative distance D from target 40 to liquid lens 20.

In other embodiments, distance detection system 39 may be a laser-based range finding system such as Qtrace™ available from Metrologic Instruments, Incorporated which is capable of measuring linear distances within ±6 mm. Representative laser range finding systems that may be implemented in the preferred embodiment may include without limitation time-of-flight using pulsed lasers or continuous wave amplitude (or frequency) using modulated lasers (including phase detection in some embodiments), In other embodiments, interferometry may be used in distance detection system 39. Other suitable commercially available distance measuring systems may be used without limitation so long as the distance to target 40 can be measured and converted into a data signal which can be relayed to microprocessors 33, control circuitry 35, or both for adjusting the focus of liquid lens 20.

With continued reference to FIGS. 2A and 2B, distance detection system 39 communicates with control circuit 35 via a data communication link 38. Distance detection system 39 generates a data signal that includes information regarding the distance D to target 40 and other related relevant information as required. This distance signal is communicated to control circuit 35 over data communication link 38. In alternative embodiments, the distance data signal may also be communicated to microprocessor 33 via optional data communication link 37 instead of or in addition to control circuit 35. Microprocessor 33 may provide control signals back to control circuit 35 via data communication link 34 to adjust control circuit 35 for optimizing the focusing of liquid lens 20 and reading of data from the target image.

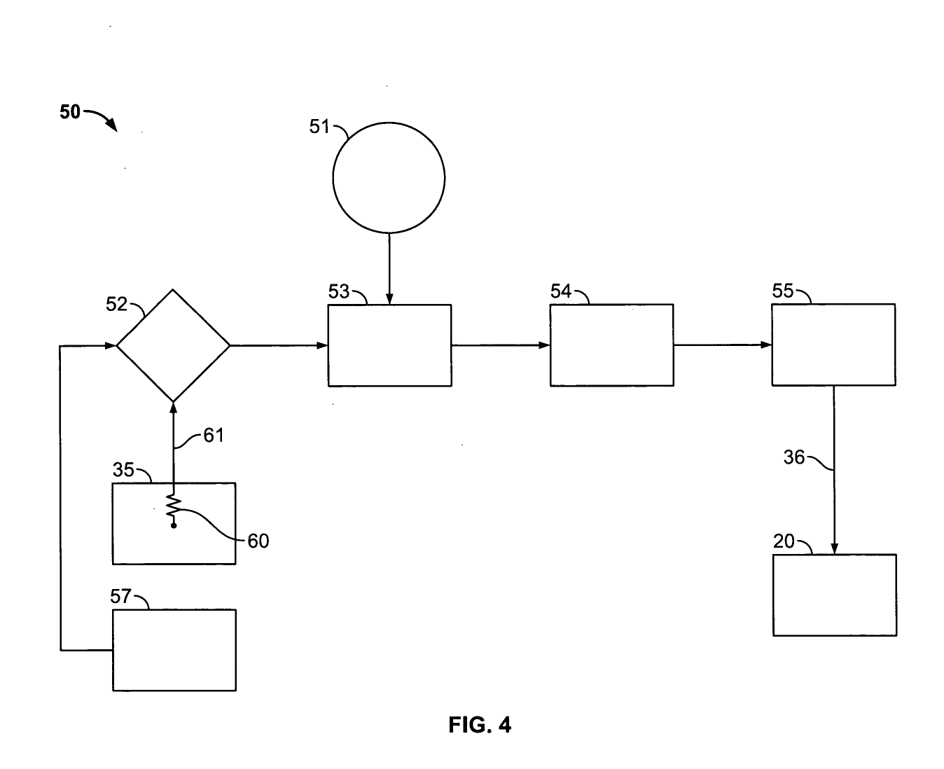

In one embodiment, control circuit 35 is functionally associated with liquid lens 20 and operates as a focus and zoom control for the liquid lens system (depending on the configuration of the lens system selected). Therefore, control circuit 35 serves as an interface between distance detection system 39 and liquid lens 20. Accordingly, in a preferred embodiment, control circuit 35 includes a liquid lens driver 50 which in one possible embodiment may be configured as shown in the block diagram of FIG. 4. Liquid lens driver 50 generally includes in sequence a power supply 57 with voltage regulators, sinusoidal wave oscillator 52 which may be a 1 kHz oscillator in one embodiment, variable gain amplifier 53, current amplifier 54, and output transformer 55. In one embodiment, transformer 55 may include a 2×5V primary transformer and 230V secondary transformer. In one embodiment, a representative typical output from transformer 55 may be without limitation 0-60 Vrms 169 1 kHz sinusoidal. The output voltage from transformer 55 to liquid lens 20 is ultimately adjusted by controlling oscillator 52, which in one embodiment may be controlled by a voltage control signal 61 generated from a distance-voltage conversion circuit 60 included with control circuit 35.

Control circuit 35 preferably includes and implements associated control logic operative to automatically control the focus and zoom (in a preferred embodiment) of the liquid lens system based on the distance of target 40 to be scanned from the lens. The control logic is preprogrammed into control circuit 35 and is operative to convert distance-related information received from and transmitted with a distance data signal generated by distance detection system 39 (over data communication link 38) into a corresponding voltage control signal 61. Voltage control signal 61 is provided to and controls oscillator 52 to regulate the output voltage from transformer 55 which in turn becomes the input voltage V to liquid lens 20 via power link 36, thereby electronically adjusting the focus/zoom of the liquid lens system. The distance-voltage conversion control logic may be implemented in hardware, firmware, software, or any combination thereof. Accordingly, the terms “circuitry” or “circuit” as used herein means any combination of hardware, firmware, or software used to implement the control logic, and/or to process control or power signals. The terms “circuitry” or “circuit” further are used interchangeably herein.

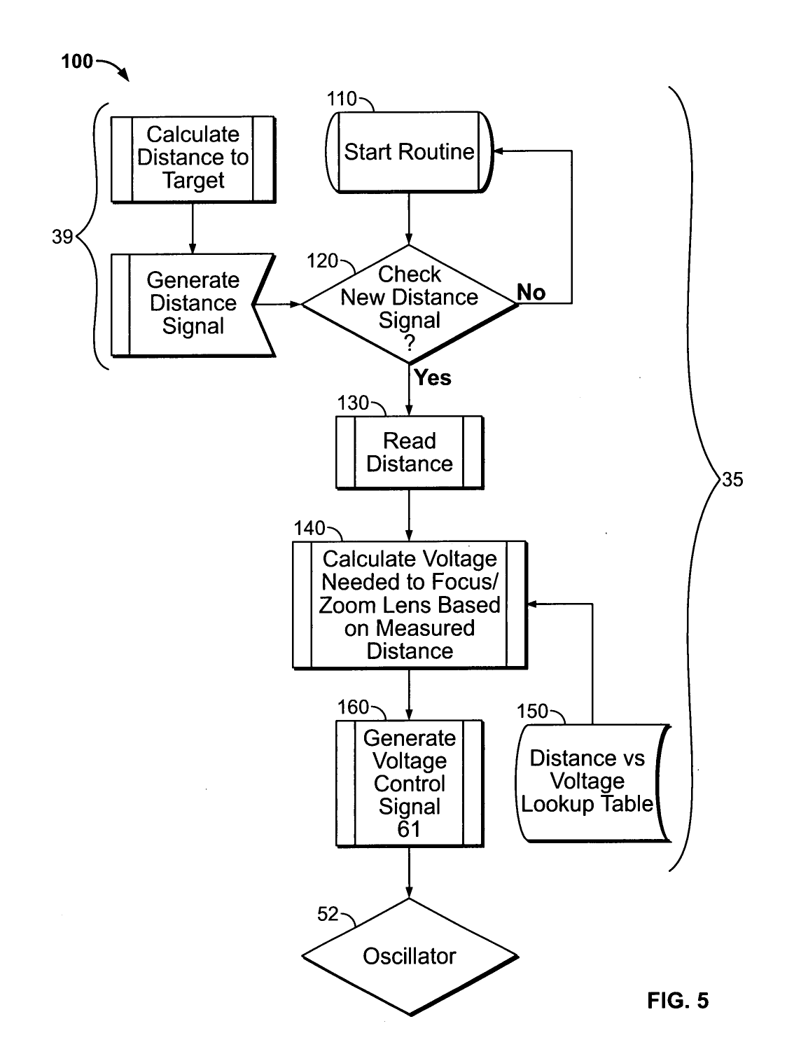

Referring to FIG. 5, exemplary control logic is shown for controlling the focus/zoom of liquid lens system 25 by determining an appropriate output voltage from transformer 55 to liquid lens 20 based on the distance measured to target 40 by distance detection system 39. As discussed above, distance detection system 39 measures the distance to target 40 and generates a distance signal containing the distance information each time a new target is detected within its field of view (FOV). The control logic will be explained using a non-limiting example of reading a barcode target with a scanner. However, it will be appreciated that any type of target may be used according to principles of the present invention.

Logic process 100, which preferably is implemented by and preprogrammed into control circuit 35 in one embodiment, begins with step 110 in which the routine is started. In step 120, the control logic continuously checks for a new distance signal from distance detection system 39 indicating a new target has been presented for scanning. If a new signal is not detected, control returns to step 110. If a new distance signal is detected, control continues with step 130 in which the measured distance is read. In next step 140, a voltage based on and corresponding to the measured distance D to target 40 is calculated. The voltage determined will represent the input voltage V required to adjust the focus of liquid lens 20 to the optimal focal length (based on the distance D to the barcode target 40, represented in FIG. 6 as discussed above) that is needed to achieve maximum resolution of the target for reading the barcode. It is well within the ambit of one skilled in the art to readily develop input liquid lens voltages corresponding to measured target distances D needed to focus (and zoom in some preferred embodiments) liquid lens 20.

In one embodiment, step 140 may be completed by providing access to and retrieving data from a look-up table 150 that preferably includes a plurality of voltage values versus corresponding distance values D. Look-up table 150 is pre-programmed into the control logic in a preferred embodiment. In other embodiments, however, look-up table 150 may be stored on a circuit or computer readable medium stored remote from but accessible to control circuit 35. In step 140, the control logic accesses lookup table 150 and determines a voltage value corresponding to and based on the measured distance D to the target 40, thereby indirectly selecting the appropriate lens focal length curve C (shown in FIG. 6) needed to bring target 40 into focus for reading the barcode target. It should be noted that other methods of achieving the same result of correlating target distance D to liquid lens input voltages other than using a lookup table may be used and implemented by the control logic. For example, in other embodiments, it is well within the knowledge of one skilled in the art to reduce the focal length data represented in FIG. 6 to a mathematical expression that further includes a correlation to required input voltages to adjust the focus of liquid lens 20. The mathematical expression can be stored in control circuit 35 and resolved based on the measured distance D to target 40. Accordingly, the invention is not limited to the manner in which control circuit 35 calculates a voltage for liquid lens 20 based on measured distance D so long as the voltage required to focus liquid lens 20 to target 40 may be determined.

With continued reference to FIG. 5, once step 140 is completed and the required voltage is determined to focus liquid lens 20, a voltage control signal is generated in step 160 which is received by oscillator 52 in liquid lens driver 50 (see FIG. 4). Oscillator 52 is adjusted to produce the required output voltage from liquid lens driver 50 needed to focus liquid lens 20 to read the barcode. The focal length or distance of liquid lens 20 selected will substantially match the distance D from the lens to the target, wherein the term “substantially” is used to define an acceptable ± distance tolerance so long as the barcode can be resolved and read by the scanner. Accordingly, the accuracy of autofocus system 30 need not match the focal distance of liquid lens 20 to distance D of the target to the lens exactly.

In a preferred embodiment, microprocessor 33 includes software and control logic operative to read and process bar code information received from either: (1) liquid lens 20 via data communication link 32 in the case of a barcode reader autofocus system shown in FIG. 2A, or from (2) photocell 68 via data communication link 64 in the case of a laser scanner autofocus shown in FIG. 2B. Data communication links 32 and 64 may be wired (e.g., cable) or wireless using which may in part depend on whether microprocessor 33 is located on-board in scanner housing 69 or external to the housing. Suitable commercially available wireless technologies that may be used include Bluetooth,® infrared, RF, etc.

In a preferred embodiment, autofocus system 30 including liquid lens 20 and distance detection system 39 are sized and configured to be disposed in a portable, compact package such as a handheld housing 69. In one embodiment, the handheld housing 69 may be a portable barcode scanner.

A preferred method of using the autofocus system 30 is in barcode scanning/reading applications, and more preferably without limitation performing a scanning operation using a handheld laser barcode scanner. The method will now be described with reference to an exemplary laser barcode scanner and FIGS. 2B and 5. However, it will be appreciated that the autofocus system described herein may be used in any other application and is not limited to barcode scanners.

The exemplary method includes providing a barcode scanner incorporating an autofocus system 30. The scanner includes a housing 69 that preferably contains and supports liquid lens 20 and distance detection system 39 In a preferred embodiment, housing 69 is sized and configured small enough to be a portable for holding in the hand of a user such as a handheld laser barcode scanner. In other embodiments, however, it should be noted that the housing 69 may be a fixed mount barcode scanner or engine.

With continuing reference to the handheld laser barcode scanner example and FIGS. 2B and 5, the method continues by presenting a barcode target 40 to a user. Barcode target 40 may be emplaced on any type of object to be scanned. The user next aims the handheld scanner at barcode target 40. The distance detection system 39 measures the distance D to the target and generates a distance signal that is received by liquid lens control circuit 35 over data communication link 38. In one embodiment, distance-voltage conversion circuit 60 incorporated with control circuit 35 implements the control logic in the manner described above. The measured distance D to the barcode target 40 is used by the control logic to calculate a corresponding voltage value required to adjust liquid lens 20 to the optimal focal length required to focus laser beam 66 on the target and read the barcode. As described in detail above, an input voltage V is generated and transmitted to liquid lens 20 and the focal length of the lens is adjusted accordingly in a quick and efficient manner. Scanner laser beam source 65, also preferably included in the housing 69, generates laser beam 66 which is projected through liquid lens 20 and onto barcode target 40. Because the laser beam is optimally focused by liquid lens 20 in advance to produce the smallest size dot on barcode target 40 needed for satisfactorily resolving the barcode based on the distance D measured to the target, the barcode advantageously is quickly and efficiently read without the user having to move the handheld scanner back and forth as needed in manual scanning operations in the past. Photocell 68 receives reflected light from barcode target 40 as described above and communicates the light-based information received to microprocessor 33 via data communication link 64 for decoding and further processing to read the barcode data.

In the base of an imaging scanner, the preferred method includes adjusting the focus of liquid lens 20 based on distance D measured to barcode target 40 in the same manner described above for the laser scanner. In this case, however, the light reflected from the barcode is received by liquid lens 20 and focused onto image sensor 31 closely coupled to the lens. The barcode image data is processed by image sensor 31 and transmitted to microprocessor 33 via data communication link 32 as described elsewhere herein.

In some barcode image reader applications, it may be desirable to provide visual feedback to the user in order to indicate the effective field of view (FOV) after the focus and zoom ratio (if this function is provided) is set for liquid lens 20 assembly by autofocus system 30. In an optional embodiment, referring to FIG. 3, targeting and framing of barcode target 40 may be implemented with a second targeting liquid lens 70 that is controlled similarly to imaging liquid lens 20 described herein by either: (1) a separate control circuit 75 (with a second liquid lens driver 50) that receives a distance signal 76a from distance detection system 39 and generates an output voltage delivered to liquid lens 70 via power link 77 (see FIG. 3); or alternatively (2) liquid lens 70 concurrently receives the same output voltage signal from transformer 55 in control circuit 35 via power links 76b, 77. In either case, the focal length of targeting liquid lens 70 is adjusted to match that of imaging liquid lens 20. In one embodiment, liquid lens 70 therefore projects a visible targeting pattern 72 on the target 40 with a zoom ratio that is substantially the same as the imaging liquid lens 20. Accordingly, the pattern 72 represents the current zoom level of imaging liquid lens 20 and allows the user to verify that the entire barcode image will be captured by the barcode reader. The targeting pattern 72 may be projected using a visible laser diode (VLD) 71.

In a preferred embodiment, the targeting liquid lens 70, imaging liquid lens 20, distance detection system 39, and all associated control circuitry shown in FIG. 3 (with possible exception of microprocessor 33) may be contained in a single housing 69, In one embodiment, the housing 69 with focus, zoom, distance detection, and visible targeting preferably may be sized and configured to be handheld, and more preferably may be handheld barcode reader.

While the foregoing description and drawings represent preferred or exemplary embodiments of the present invention, it will be understood that various additions, modifications and substitutions may be made therein without departing from the spirit and scope of the present invention as defined in the accompanying claims. In particular, it will be clear to those skilled in the art that the present invention may be embodied in other specific forms, structures, arrangements, proportions, sizes, and with other elements, materials, and components, without departing from the spirit or essential characteristics thereof. One skilled in the art will appreciate that the invention may be used with many modifications of structure, arrangement, proportions, sizes, materials, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments. Rather, the appended claims should be construed broadly, to include other variants and embodiments of the invention, which may be made by those skilled in the art without departing from the scope and range of equivalents of the invention.

What is claimed is:

1. A liquid lens autofocus system comprising:
a first liquid lens having a variable focal length that is adjustable by varying an input voltage to the liquid lens;
distance detection circuitry being operative to measure a distance to a target to be scanned;
control circuitry associated with the first liquid lens for focusing the lens, the control circuitry being operative to receive a signal from the distance detection circuitry representing a measured distance to the target; and
control logic implemented by the first liquid lens control circuitry and being operative to calculate a first voltage value corresponding to the measured distance to the target, the control circuitry generating an output voltage approximating the first voltage value to adjust the focus the first liquid lens.

2. The autofocus system of claim 1, wherein the control logic includes a lookup table containing a plurality of voltage values versus corresponding distance values, the control logic accessing the lookup table to calculate the first voltage value based on the measured distance to the target.

3. The autofocus system of claim 1, wherein first voltage value is calculated by the control logic using a mathematical expression based on the measured distance to the target.

4. The autofocus system of claim 1, wherein the distance detection circuitry uses infrared, LED, laser, or interferometry range finding to measure the distance to the target.

5. The autofocus system of claim 1, wherein the control logic is implemented in hardware, firmware, software, or a combination thereof.

6. The autofocus system of claim 1, wherein the target is a barcode.

7. The autofocus system of claim 1, wherein the autofocus system is sized and configured to fit in handheld scanner.

8. The autofocus system of claim 7, wherein the handheld scanner is a barcode scanner.

9. The autofocus system of claim 1, further comprising the liquid lens forming part of a zoom lens system and control logic implemented by the first liquid lens control circuitry that calculates a zoom ratio based on the measured distance to the target.

10. A scanner with liquid lens autofocus system comprising:
a housing;
distance detection circuitry disposed in the housing and being operative to measure a distance to a target;
a first liquid lens disposed in the housing and having a variable focal length that is adjustable by varying an input voltage to the liquid lens;
control circuitry associated with the first liquid lens for focusing the lens, the control circuitry being operative to receive a signal generated by the distance detection circuitry representing a measured distance to the target; and
control logic implemented by the liquid lens control circuitry, the control logic operative to read the measured distance to the target and calculate a first voltage value corresponding to the measured distance,
wherein the control circuitry generates an output voltage equal to the calculated first voltage value to adjust the focal length of the first liquid lens.

11. The scanner of claim 10, further comprising a laser source supported by the housing and operative to generate a laser beam, the laser beam being focused on the target through the first liquid lens.

12. The scanner of claim 10, wherein the housing is sized and configured for being held in a hand of a user.

13. The scanner of claim 10, wherein the target is a barcode.

14. The scanner of claim 10, wherein the control logic includes a lookup table containing a plurality of voltage values versus corresponding distance values, the control logic accessing the lookup table to calculate the first voltage value based on the measured distance to the target.

15. The scanner of claim 10, wherein first voltage value is calculated by the control logic using a mathematical expression based on the measured distance to the target.

16. The scanner of claim 10, wherein the distance detection circuitry uses an infrared, LED, laser, or interferometry range finding to measure the distance to the target.

17. The scanner of claim 10, further comprising a second liquid lens or a second and third fixed lens in combination with the first liquid lens to define a zoom lens system.

18. The scanner of claim 10, wherein the first liquid lens receives and focuses reflected light on a full array image sensor.

19. The scanner of claim 18, wherein the image sensor is a CCD or CMOS.

20. A method of focusing a liquid lens on a target comprising the steps of:
providing a liquid lens having a focal length that is adjustable by varying an input voltage to the liquid lens;
presenting a target separated from the liquid lens by a distance;
measuring the distance to the target with a distance detection system;
calculating a first voltage value corresponding to the measured distance to the target;
generating a focus control voltage based on the first voltage value;
receiving the focus control voltage by the liquid lens; and
adjusting the focal length of the liquid lens based on the focus control voltage.

21. The method of claim 20, wherein the calculating step includes implementing control logic to calculate the first voltage value based on the measured distance to the target.

22. The method of claim 20, wherein the calculating step includes implementing control logic operative to match the measured distance to the target to the first voltage value.

23. The method of claim 22, wherein the control logic accesses a lookup table including a plurality of voltage values versus corresponding distance values to perform the match.

24. The method of claim 20, wherein the distance detection system includes circuitry that uses an infrared, LED, laser, or interferometry range finding to measure the distance to the target.

25. The method of claim 20, further comprising a step of projecting a laser beam through the liquid lens onto the target.

26. The method of claim 20, wherein the target is a barcode.

27. The method of claim 20 wherein the liquid lens is disposed in a housing that is sized and configured for being held in a hand of a user.

28. The method of claim 27, wherein the distance detection system is also disposed in the housing.

29. The method of claim 20, further comprising a step of receiving an image reflected from the target by the liquid lens.

30. The method of claim 29, further comprising a step of capturing the image on a CCD or CMOS image sensor.
